(19) United States
(12) Patent Application Publication
(10) Pub. No.: US 2024/0054423 A1
(43) Pub. Date: Feb. 15, 2024

(54) CONTRACT ASSISTANCE SYSTEM AND COMPUTER PROGRAM PRODUCT

(71) Applicant: Katsunori SUETSUGU, Tokyo (JP)

(72) Inventor: Katsunori SUETSUGU, Tokyo (JP)

(21) Appl. No.: 18/317,708

(22) Filed: May 15, 2023

(30) Foreign Application Priority Data
Aug. 11, 2022 (JP) 2022-128551

(51) Int. Cl. G06Q 10/0635; G06Q 50/18

(52) U.S. Cl. CPC G06Q 10/0635; G06Q 50/188

(57) ABSTRACT

Provided is a contract assistance system and computer program product capable of analyzing the content of a contract that is fair between contractors. A contract assistance system includes a contract terms setting unit configured to set contract terms including premise items serving as premises of a contract and a simulation item to be simulated, a contract analysis data storage unit configured to store contract analysis data used to analyze the contract, a contract analysis unit configured to analyze a central state of the simulation item that makes the content of the contract fair between the contractors, on the basis of the contract analysis data stored in the contract analysis data storage unit and the contract terms set by the contract terms setting unit, and a contract analysis results presentation unit configured to present analysis results obtained by the contract analysis unit.

### TECHNICAL FIELD

The present invention relates to a contract assistance system and computer program product that assist a user in making a contract having content that is balanced between contractors and is appropriate.

### BACKGROUND ART

Conventionally, when a company makes a contract with a business partner, the company has difficulty in determining whether the content of the contract is fair between the contractors, advantageous to the company, or advantageous to the partner. Also, when the content of the contract deviates from the central state (the “central value” when the central state is represented by a value), which represents being fair between the contractors, a person in charge of making contracts in the company does not know what level of risk is present or whether the risk can cause monetary loss. For this reason, when making a contract, the person finds a compromise intuitively and empirically in consideration of the profitable line of each transaction, that is, has difficulty in determining a compromise by weighing risks and benefits.

For example, the risk of a contract varies depending on what and to what extent the damages provision in the contract includes, such as whether the range of the damages provision is limited to ordinary damages under the Civil Code, or includes even lost profits, or includes even indirect damages, or includes even special damages, or includes even punitive damages in consideration of transactions in the US.

To solve such a problem, Japanese Unexamined Patent Application Publication No. 2019-128893 describes a contract construction system that when creating a contract, allows a user to make a selection on to which party of the contract the elements of the contract are advantageous.

See Japanese Unexamined Patent Application Publication No. 2019-128893.

### SUMMARY OF INVENTION

However, when creating a contract using the contract construction system of Japanese Unexamined Patent Application Publication No. 2019-128893, a user has difficulty in conducting simulation or study on to which contractor the contract as a whole is advantageous, whether the words of the contract should be changed to balance the contractors, to what extent the contract in the fair central state is advantageous to each contractor, or what level of risk will occur when the words of the contract are partially changed.

The present invention has been made in view of the above problems, and an object thereof is to provide a contract assistance system and computer program product capable of analyzing the content of a contract that is fair between contractors.

To accomplish the above object, a contract assistance system according to one aspect of the present invention is a contract assistance system for assisting in analysis of a contract to be made between contractors. The contract assistance system includes a contract terms setting unit configured to set contract terms including premise items serving as premises of the contract and a simulation item to be simulated, a contract analysis data storage unit configured to store contract analysis data used to analyze the contract, a contract analysis unit configured to analyze a central state of the simulation item that makes content of the contract fair between the contractors, on the basis of the contract analysis data stored in the contract analysis data storage unit and the contract terms set by the contract terms setting unit, and a contract analysis results presentation unit configured to present analysis results obtained by the contract analysis unit.

The contract assistance system according to the one aspect of the present invention analyzes the central state of the simulation item that makes the content of the contract fair between the contractors and presents the analysis results. Thus, the contract assistance system allows a user to know the content of the contract that is fair between the contractors, that is, assists the user in making the contract.

In the contract assistance system according to the one aspect of the present invention, the contract analysis unit may be configured to determine, as the central state, a state in which risks borne by the contractors and profits earned by the contractors are balanced, by changing the simulation item, and the contract analysis results presentation unit may be configured to present information on the central state determined by the contract analysis unit.

According to the one aspect of the present invention, the user is able to know the central state that makes the content of the contract fair between the contractors.

In the contract assistance system according to the one aspect of the present invention, the contract analysis unit may be configured to calculate the risks borne by the contractors by determining a risk factor and a cost factor for each of words of the contract and calculating the probabilities that the risk factor and the cost factor respectively will occur.

According to the one aspect of the present invention, the user is able to know the risks based on the words of the contract.

In the contract assistance system according to the one aspect of the present invention, when the words of the contract constituting the premise items are changed, the contract terms setting unit may be configured to change the set premise items, and the contract analysis unit may be configured to re-analyze the central state of the simulation item on the changed premise items.

According to the one aspect of the present invention, when the words of the contract constituting the premise items are changed, the user is able to know the central state of the simulation item.

In the contract assistance system according to the one aspect of the present invention, the contract analysis unit may be configured to re-analyze the risks changed responsive to the words of the contract being changed, and the contract analysis results presentation unit may be configured to present information on the re-analyzed risks such that the information is associated with the changed words.

According to the one aspect of the present invention, when the words of the contract are changed, the user is able to grasp the risks.

A computer program product according to another aspect of the present invention is a computer program product for assisting in analysis of a contract to be made between contractors. The computer program product causes a computer to function as contract terms setting means configured to set contract terms including premise items serving as premises of the contract and a simulation item to be simulated, contract analysis data storage unit configured to store contract analysis data used to analyze the contract, contract analysis means configured to analyze a central state of the simulation item that makes content of the contract fair between the contractors, on the basis of the contract analysis data stored in the contract analysis data storage unit and the contract terms set by the contract terms setting unit, and contract analysis results presentation means configured to present analysis results obtained by the contract analysis means.

The computer program product according to the another aspect of the present invention analyzes the central state of the simulation item that makes the content of the contract fair between the contractors and presents the analysis results. Thus, the computer program product allows a user to know the content of the contract that is fair between the contractors, that is, assists the user in making the contract.

A contract assistance system according to yet another aspect of the present invention is a contract assistance system for assisting in analysis of a contract to be made between contractors. The contract assistance system includes a contract terms setting unit configured to set contract terms including premise items serving as premises of the contract and a simulation item to be simulated on the basis of input of a setting from outside, a contract analysis data storage unit configured to store contract analysis data including simulation learning data, standard profit calculation data for calculating the amounts of standard profits earned by the contractors in accordance with content of the contract between the contractors, and risk amount calculation data for calculating the amounts of risks on the basis of a risk factor and a cost factor that may occur in the respective contractors, the contract analysis data being used to simulate a central state in which real profits obtained by subtracting the amounts of risks borne by the contractors from gross profits earned by the contractors become the amounts of standard profits, by changing the simulation item, a contract analysis unit configured to analyze a state of the simulation item in which the central state is obtained, on the basis of the contract analysis data stored in the contract analysis data storage unit and the contract terms set by the contract terms setting unit, and a contract analysis results presentation unit configured to present analysis results obtained by the contract analysis unit. When words of the contract constituting the premise items are changed, the contract terms setting unit is configured to change the set premise items, and the contract analysis unit is configured to re-analyze the state of the simulation item in which the central state is obtained, on the basis of the changed premise items.

According to the yet another aspect of the present invention, a user is able to, when sequentially changing the words of the contract constituting the premise items, sequentially grasp the state of the simulation item in which the re-analyzed central state is obtained. Thus, the user is able to sequentially grasp the risks, the profits, whether the content of the contract is advantageous or disadvantageous, or the like. This assists the user in making the contract that is balanced between the contractors.

In the contract assistance system according to the yet another aspect of the present invention, if the premise items set by the contract terms setting unit are addresses of the contractors and the simulation item is a court of jurisdiction and the amount of transactions between the contractors, the contract analysis unit may be configured to calculate the amounts of risks of the contractors on the basis of the probabilities that the contractors respectively will go to the court of jurisdiction and costs associated with going of the contractors to the court of jurisdiction, to calculate the real profits earned by the contractors due to the transactions between the contractors, and to determine the central state that corresponds to the amount of transactions and in which a court having jurisdiction over the address of one of the contractors is specified as the court of jurisdiction, by changing the court of jurisdiction and the amount of transactions between the contractors being the simulation item.

In the contract assistance system according to the yet another aspect of the present invention, if the premise items set by the contract terms setting unit are liability for damages between the contractors and the simulation item is the amount of transactions between the contractors, the contract analysis unit may be configured to calculate the amounts of risks of the contractors on the basis of the probabilities that damage will occur in the respective contractors and the amounts of damages corresponding to the liability for damages associated with occurrence of damage, to calculate the real profits earned by the contractors due to the transactions between the contractors, and to determine the amount of transactions at which the central state is obtained, by changing the amount of transactions between the contractors being the simulation item.

In the contract assistance system of the yet another aspect of the present invention, if the simulation item is not set in accordance with input of a setting from outside, the contract terms setting unit may be configured to set the real profits of the contractors as the simulation item that is a default, and the contract analysis results presentation unit may be configured to present the real profits and the standard profits of the contractors and size relationships between the real profits and the standard profits.

The contract assistance system according to the yet another aspect of the present invention may further include a standard data storage unit configured to store standard data representing standard contracts corresponding to industries or transaction forms and central states determined on the basis of the standard contracts. If the contract analysis unit cannot determine the central state, the contract analysis results presentation unit may be configured to present the standard data stored in the standard data storage unit in accordance with industries of the contractors or a transaction form between the contractors.

A computer program product according to a still yet another aspect of the present invention is a computer program product for causing a computer to function as contract terms setting means configured to set contract terms including premise items serving as premises of a contract to be made between contractors and a simulation item to be simulated, contract analysis data storage means configured to store contract analysis data including simulation learning data, standard profit calculation data for calculating the amounts of standard profits earned by the contractors in accordance with content of the contract between the contractors, and risk amount calculation data for calculating the amounts of risks on the basis of a risk factor and a cost factor that may occur in the respective contractors, the contract analysis data being used to simulate a central state in which real profits obtained by subtracting the amounts of risks borne by the contractors from gross profits earned by the contractors become the amounts of standard profits, by changing the simulation item, contract analysis means configured to analyze a state of the simulation item in which the central state is obtained, on the basis of the contract analysis data stored in the contract analysis data storage means and the contract terms set by the contract terms setting means, and contract analysis results presentation means configured to present analysis results obtained by the contract analysis means. When words of the contract constituting the premise items are changed, the contract terms setting means is configured to change the set premise items, and the contract analysis means is re-analyze the state of the simulation item in which the central state is obtained, on the basis of the changed premise items.

### BRIEF DESCRIPTION OF DRAWINGS

FIG. 1 is a diagram showing the overall configuration of a contract assistance system according to an embodiment of the present invention;

FIG. 2 is a diagram showing the functional components of a server included in the contract assistance system according to the embodiment; and

FIG. 3 is a flowchart showing process steps performed by the contract assistance system according to the embodiment.

### DESCRIPTION OF EMBODIMENTS

Now, an embodiment of the present invention will be described in detail with reference to the drawings.

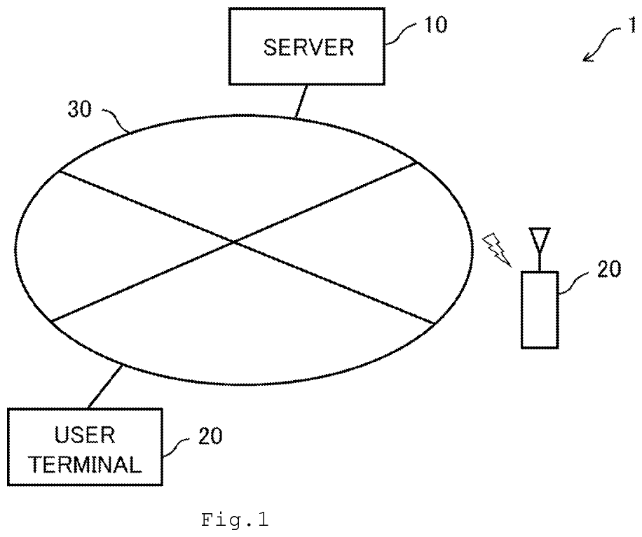

FIG. 1 is a diagram showing the overall configuration of a contract assistance system 1 according to the embodiment of the present invention. As shown in FIG. 1, the contract assistance system 1 includes a server 10 that stores various types of data, an analysis algorithm, and the like and analyzes contracts, a user terminal 20 used by a user to analyze contracts, and a communication network 30, such as the Internet or mobile communication network, through which the devices 10 and 20 are communicatively connected to each other.

The user terminal 20 is, for example, a smartphone. Note that the user terminal 20 is not limited to the smartphone and only has to be a communicative computer capable of displaying and editing document data in which the content of contracts is described. For example, the user terminal 20 may be a tablet device or PC.

The server 10 includes, as hardware, a CPU, a storage device including RAM, ROM, and hard disk, and a communication interface that enables communication through the communication network 30. The storage device of the server 10 are storing software such as various types of data, databases, and programs.

Data stored in the storage unit of the server 10 includes contract terms set by the user, default contract terms, contract analysis data used to analyze contracts, and the like.

The programs stored in the storage unit of the server 10 include a program for calculating risks borne by contractors under set contract terms, a program for calculating profits earned by the contractors, a program for determining the central state that makes the content of the contracts fair between the contractors, a program for determining a risk for each of the words or provisions of the contracts, and the like.

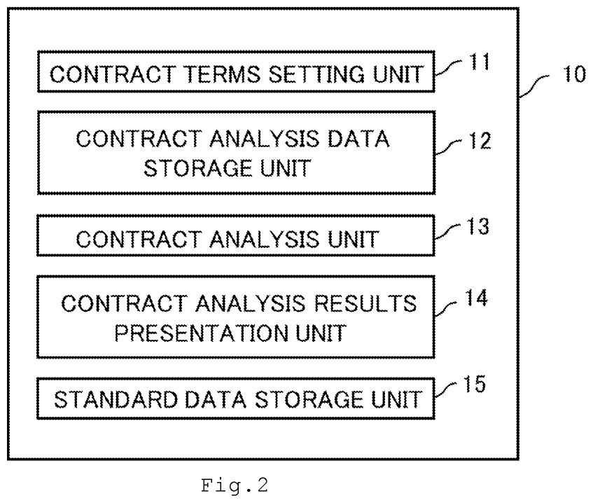

When the CPU of the server 10 performs processing in accordance with software stored in the storage unit, functional components shown in FIG. 2 are implemented in the server 10.

The contract terms setting unit 11 sets contract terms including premise items serving as premises of a contract to be made between contractors and a simulation item to be simulated.

Specifically, in the present embodiment, the contract terms are set as follows. By operating the user terminal 20, the user displays document data in which the words of the contract are described, on the user terminal 20 and sets a contract having, as the “premise items,” the entire words of document displayed on the screen. While, in the present embodiment, “real profits obtained by the contractors” is set as the “simulation item” by default, the user may change the default simulation item by inputting a setting. Conceivable methods for setting the “simulation item” include selection from options displayed on the screen, input by character, and the like.

Upon detection of the setting of the contract terms on the user terminal 20, the contract terms setting unit 11 sets the premise items and simulation item as contract terms.

When the user changes the words of the contract displayed on the screen by input, the contract terms setting unit 11 changes the set premise items. Note that when changing the words, words may only be added or deleted.

A specific example of the “simulation item” will be described. For example, the risk of a contract varies depending on what and to what extent the damages provision in the contract includes, such as whether the range of the damages provision is limited to ordinary damages under the Civil Code, or includes even lost profits, or includes even indirect damages, or includes even special damages, or includes even punitive damages in consideration of transactions in the US. In this case, “damages provision” can be set as the “simulation item.”

With respect to liability for non-compliance, the risks to be borne or expected profits are affected by the product warranty period after delivery. In this case, “warranty period after delivery” can be set as the “simulation item.”

With respect to representations and warranties on intellectual properties, the expected risks or costs vary depending on whether the person or corporation concerned simply warrants in the contract that there is no infringement of intellectual property rights held by a third party, or warrants “to the person or corporation's knowledge”, or warrants “to the best of the person or corporation's knowledge.” “To the person or corporation's knowledge” is a subjective matter of whether the person or corporation knows. “To the best of the person or corporation's knowledge” is a matter of to what extent the person or corporation can know objectively, since all research methods, means, and the like present in the world have to be considered. In this case, “representations and warranties on intellectual properties,” can be set as the “simulation item.”

With respect to damage, the risks vary depending on whether damage includes that caused by slight negligence or whether liability for slight negligence is excluded. In this case, “slight negligence with respect to damage” can be set as the “simulation item.”

With respect to the upper limit of damages, the risks vary depending on whether the amount of transactions in the last year or the amount of transactions in the last half year is set as the upper limit. In this case, “upper limit of damages” can be set as the “simulation item.”

The risks also vary depending on whether the governing law in overseas transactions is laws of Japan or laws of the overseas country concerned or whether the language of the original contract is Japanese or foreign language. In this case, “governing law in overseas transactions” can be set as the “simulation item.”

In the case of trade transactions, the costs vary depending on whether products are delivered to the overseas factory concerned, or to the overseas port concerned, or to the site concerned in Japan, which is the import destination. In this case, “product delivery site in trade transactions” can be set as the “simulation item.”

A contract analysis data storage unit 12 stores contract analysis data used to analyze contracts set by the contract terms setting unit 11, in a database or the like disposed in the hard disk of the server 10. Note that the contract analysis data may be stored in the database of another server rather than the database of the server 10. In this case, the server 10 assesses the database of the other server to acquire the contract analysis data, as necessary.

The “contract analysis data” will be described in detail. The “contract analysis data” refers to data used to simulate the “central state” by changing the “simulation item.” The “central state” refers to the state of the simulation item that makes the content of the contract fair between the contractors (the “central value” when the state is represented by a value). In the present embodiment, the “central state” refers to a state in which real profits obtained by subtracting the amounts of risks borne by the contractors from gross profits earned by the contractors become equal to the amounts of standard profits, as will be described later. The “contract analysis data” includes simulation learning data, standard profit calculation data for calculating the amounts of standard profits earned by the contractors in accordance with the content of the contract between the contractors, and risk amount calculation data for calculating the amounts of risks on the basis of a risk factor and a cost factor that may occur in the respective contractors.

Specifically, the “contract analysis data” includes various types of laws, regulations, and rules, past judicial precedents and cases, the simulation learning data, the standard profit calculation data, risk factor data, cost factor data, damages calculation data, data on the course of negotiations between the contractors, and the like. The standard profit calculation data includes an algorithm for calculating the standard profits earned by the contractors in accordance with the content of the contract. The risk factor data includes the records of accidents at the time of delivery in industries, the records of defective products, the records of affected lost profits, the records of damages in courts, the records of settlement money, widespread business practices in counties or regions, and the like. The damages calculation data includes the probabilities that risks can occur in the respective contractors in accordance with the content of the contract, and an algorithm for calculating the expected values of damages associated with the occurrence of that risks.

A standard data storage unit 15 stores standard data indicating standard contracts corresponding to industries or transaction forms and the central states determined on the basis of the contracts in a database or the like disposed in the hard disk of the server 10.

The contract analysis unit 13 analyzes the central state of the simulation item, which makes the content of the contract fair between the contractors, on the basis of the contract analysis data stored in the contract analysis data storage unit 12 and the contract terms set by the contract terms setting unit 11 (that is, analyzes the state of the simulation item in which the central state is obtained).

Specifically, the contract analysis unit 13 determines, as the central state, a state in which the risks borne by the contractors and the profits earned by the contractors are balanced, by changing the simulation item.

The profits are calculated as follows. The contract analysis unit 13 calculates the gross profits earned by the contractors on the basis of the contract analysis data stored in the contract analysis data storage unit 12 and the contract terms set by the contract terms setting unit 11. The contract analysis unit 13 then calculates the real profits by subtracting the amounts of risks from the gross profits.

The contract analysis unit 13 also calculates standard profits serving as median profits corresponding to the contract terms on the basis of the standard profit calculation data in the contract analysis data stored in the user terminal 20.

The risks are calculated as follows. The contract analysis unit 13 calculates the risks borne by the contractors by determining a risk factor and a cost factor for each of the words of the contract and calculating the probabilities that the risk factor and cost factor respectively will occur.

A specific example of risk calculation will be described below. For example, the contract analysis unit 13 calculates the probabilities that damage will occur in the countries and industries of the contractors, the transaction form (outsourcing, contract, etc.), the transaction period, and the like, using past records, simulation methods, and the like in data sources stored in the contract analysis data storage unit 12. The contract analysis unit 13 then calculates the expected values of damage by multiplying the probabilities that damage will occur by the amounts of damage calculated on the basis of court precedents, settlement money, attorney's fee, expenses, the course of negotiations, widespread business practices, and the like.

One example of the course of negotiations is a case in which a promise to perform receiving inspection within three days from delivery is made in written interactions in the course of negotiations between the contractors, although there is no such description in the contract. In this case, the promise can be regarded as a part of contract information and used as a cost calculation factor.

One example of a widespread business practice is a case in which only delivery is performed and any of assembly, installation, setting, and explanation is not performed. In this case, if there is a contract that also requires assembly, installation, setting, and explanation at the time of delivery, assembly, installation, setting, and explanation constitute cost factors in the contract and deserve extra charges. To make this contract balanced, the words (assembly, installation, setting, explanation) serving as cost factors in the contract may be deleted. If these words are not deleted, an adjustment may be made, for example, by calculating the amount of the cost factors and adding this amount to the amount of contract.

One example of a method for calculating real profits in a contract between a company A and a company B is as follows. First, the contract analysis unit 13 calculates the gross profits of the company A and company B earned by the conclusion of the contract set as the premise items using the contract analysis data stored in the contract analysis data storage unit 12. The contract analysis unit 13 also determines the risk factor and cost factor for the company A and company B for each of the words of the contract set as the premise items, calculates the probabilities that the risk factor and cost factor respectively will occur, and converts the probabilities into the amounts of risks. The contract analysis unit 13 then calculates the expected amounts of damage as the amounts of risks on the basis of the contract analysis data stored in the contract analysis data storage unit 12 and the contract terms set by the contract terms setting unit 11 in consideration of the probabilities that damage will occur, court precedents, settlement money, attorney's fee, expenses, and the like. The contract analysis unit 13 then calculates the real profits of the company A and company B by subtracting the amounts of risks from the gross profits.

When the user changes the words of the contract constituting the premise items through an input operation on the user terminal 20 and thus the contract terms setting unit 11 changes the set premise items, the contract analysis unit 13 re-analyzes the central state of the simulation item on the basis of the changed premise items.

For example, when the user sequentially specifies, as the simulation item, the amounts of risks when the contract includes only ordinary damages, the amounts of risks when the contract includes ordinary damages but does not include lost profits, the amounts of risks when the contract does not include indirect damages, the amounts of risks when the contract does not include special damages, and the like through input operations, the contract analysis unit 13 sequentially determines the amounts of risks.

A contract analysis results presentation unit 14 presents information on the central state analyzed by the contract analysis unit 13 and the analysis results of the risks and the like.

The contract analysis results presentation unit 14 may present only the central state, or may present the central state in combination with the words of the contract, the amounts of risks, and the terms of transactions, or may present a comparison between the real profits and the standard profits serving as the central values, or may display only information on a particular contractor. Also, the amounts of risks may be displayed in parallel with a profit obtained by subtracting the cost and the selling, general and administrative expenses from the amount of transactions for a comparison, or results obtained by subtracting the amounts of risks from that profit may be displayed.

If the contract analysis unit 13 cannot determine the central state, the contract analysis results presentation unit 14 may present standard data stored in the standard data storage unit 15 in accordance with the industries of the contractors or the form of transactions between the contractors. For example, if the number of description items of the contract constituting the premise items displayed on the user terminal 20 is small and thus the number of premise items of the contract set by the contract terms setting unit 11 is small and it is still difficult to calculate the amount of transactions, an estimate, unit prices, or the like, the contract analysis results presentation unit 14 may present the central state of a contract in a general industry or transaction form.

For example, the contract analysis results presentation unit 14 may show that the contract between the company A and company B is “advantageous to A and disadvantageous to B,” “disadvantageous to A and advantageous to B,” “fair between A and B,” or the like. In this case, the contract analysis results presentation unit 14 may show that the contract alone is advantageous or disadvantageous, or is in the central state representing fairness, or may show that the contract is advantageous, disadvantageous, fair, or the like in combination with all conditions including the amount of transactions, international affairs, the price situation, the industry situation, business practices, and the national situation. The contract analysis results presentation unit 14 may qualitatively show that, for example, the contract is “advantageous,” “disadvantageous,” or “fair,” or may quantitatively show that, for example, the contract is “advantageous to the company A by one thousand yen” and “disadvantageous to the company B by one thousand yen.”

Also, when the user changes the words of the contract constituting the premise items through an input operation on the user terminal 20 and thus the contract terms setting unit 11 changes the set premise items, the contract analysis results presentation unit 14 re-analyzes the risks and presents information on the re-analyzed risks such that the information is associated with the changed words.

Specifically, when the user sequentially specifies, as the simulation item, the amounts of risks when the contract includes only ordinary damages, the amounts of risks when the contract includes ordinary damages but does not include lost profits, the amounts of risks when the contract does not include indirect damages, the amounts of risks when the contract does not include special damages, and the like through input operations, the contract analysis unit 13 sequentially determines the amounts of risks and the contract analysis results presentation unit 14 sequentially displays the amounts of risks. Thus, the user is able to check the amounts of risks while selecting the damage pattern on the screen. For example, the user is able to recognize that the amounts of risks are one million yen when the contract includes ordinary damages and the amounts of risks are five hundred thousand yen when the contract includes ordinary damages but does not include lost profits.

The amounts of risks are presented as follows. In a state in which a contract that the user wants to check is displayed on the user terminal 20, the contract analysis results presentation unit 14 displays the amount of risk of a word serving as a cost factor of the words of the contract while making the word conspicuous, for example, by coloring the word using a marker. The contract analysis results presentation unit 14 may display the amount of risk of the entire contract, or may display the amount of risk of each word or provision of the contract. In response to the user changing each word of the contract through an input operation, the amount of risk is changed.

If the user does not set the simulation item from outside, the contract terms setting unit 11 may set the “amounts of real profits of the contractors” as the default simulation item and the contract analysis results presentation unit 14 may present the amounts of real profits and the amounts of standard profits of the contractors and the size relationships between the amounts of real profits and the amounts of standard profits.

### Operation

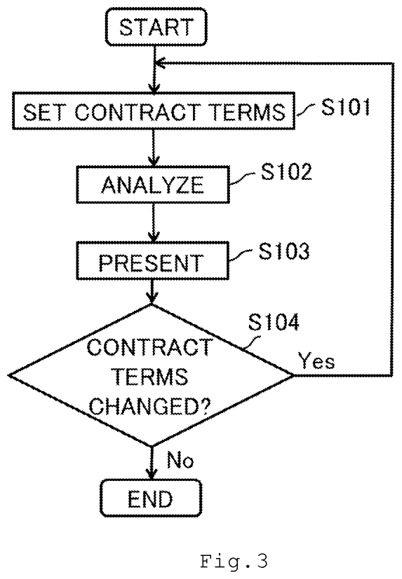

Next, referring to a flowchart shown in FIG. 3, an example of process steps performed by the contract assistance system 1 will be described.

It is assumed that the contract analysis data storage unit 12 is storing various types of contract analysis data and the user analyzes a contract to be made between the company A and company B by using the contract assistance system 1.

First, the user operates the user terminal 20 to display the contract to be analyzed on the display of the user terminal 20. The user then sets the “displayed entire contract” as the premise items and sets “damages provision to be described” as the simulation item.

The contract terms setting unit 11 stores the premise items and simulation item set by the user in the storage unit and sets contract terms (step S101).

The contract analysis unit 13 analyzes risks and profits borne or earned by the company A and company B and the content of the contract that is fair between the company A and company B on the basis of the contract analysis data stored in the contract analysis data storage unit 12 and the contract terms set by the contract terms setting unit 11 and determines the central state (step S102). Specifically, the contract analysis unit 13 changes the simulation item “damages provision to be described” (that is, changes the damages provision so that, for example, the range of the damages provision is limited to ordinary damages under the Civil Code, or includes even lost profits, or includes even indirect damages, or includes even special damages, or includes even punitive damages in consideration of transactions in the US.), performs simulations in consideration of the contract analysis data including the countries concerned, the industry standards, the transaction form, the period, international affairs, market prices, and the like, and determines the central state of the damages provision, which is a state in which the risks and profits borne or earned by the company A and company B are balanced. For example, in the case of an outsourced manufacturing contract in which the annual amount of transactions is one million yen, the contract analysis unit 13 determines that the central state of the damages provision, which makes the content of the contract fair between the company A and company B, is a damages provision including only ordinary damages.

The contract analysis results presentation unit 14 presents the analysis results obtained by the contract analysis unit 13 (step S103). For example, the contract analysis results presentation unit 14 displays the amounts of profits, the amounts of risks, and the amounts of real profits of the company A and company B and the central state of the damages provision to be described.

If the user does not set any simulation item, the contract analysis results presentation unit 14 displays the amounts of real profits and the amounts of standard profits serving as the central state of the company A and company B and whether the amounts of real profits are greater or smaller than the amounts of standard profits as default simulation items.

When the user changes the contract terms, for example, by changing the words of the contract displayed on the display of the user terminal 20 through an input operation (step S104: Yes), the process returns to step S101 and the contract terms setting unit 11 changes the set contract terms. Then, in step S102, the contract analysis unit 13 re-calculates the risks borne by the company A and company B on the basis of the changed contract terms and re-determines the central state.

Here, it is assumed that the company B wants the company A to take responsibilities by including even lost profits in the damages provision. For this reason, the user changes the premise items by changing, or making an addition to, the damages provision of the contract so that the damages provision includes even lost profits, on the basis of the analysis results of step S103 by operating the user terminal 20. The user also sets the annual amount of transactions as the simulation item. Thus, in step S101, the contract terms setting unit 11 changes the contract terms. In step S102, the contract analysis unit 13 calculates the analysis results indicating that the risks and profits are balanced when the annual amount of transactions is 50 million thousand yen, on the basis of the changed contract terms. In step S103, the contract analysis results presentation unit 14 presents the analysis results obtained by the contract analysis unit 13. Thus, the company A requests the company B to increase the amount of transactions.

Other example operations will be described below.

### Example Operation 1

It is assumed that one of the premise items states that the amount of transactions between the company A and company B of the last year is 2 million yen, the simulation item is the amount of transactions and the amounts of profits of the next year (step S101), and the profit obtained by subtracting the cost, the selling, general and administrative expenses, and the like from the amount of transactions is 200 thousand yen. In this case, in consideration of data including the countries concerned, the industries concerned, the companies concerned, the transaction, practices in the industries concerned, the period, international affairs, and the like, the contract analysis unit 13 calculates, as 3 hundred thousand yen, the amounts of profits when the annual amount of transactions is 3 million yen and determines this state as the central state (step S102).

### Example Operation 2

It is assumed that one of the premise items set by the contract terms setting unit 11 is the addresses of the contractors and the simulation item is the court of jurisdiction and the amount of transactions between the contractors. In this case, the contract analysis unit 13 calculates the amounts of risks of the contractors on the basis of the probabilities that the respective contractors will go to the court of jurisdiction and the costs associated with going to the court of jurisdiction, calculates the real profits earned by the contractors due to transactions between the contractors, and changes the court of jurisdiction and the amount of transactions between the contractors, which are the simulation item. Thus, the contract analysis unit 13 determines the central state that corresponds to the amount of transactions and in which the address of one of the contractors falls within the jurisdiction of the court.

A specific example is as follows. It is assumed that one of the premise items states that the headquarters of the company A is located in Tokyo and the headquarters of the company B is located in Fukuoka and the simulation item is the court of jurisdiction (step S101 in FIG. 3). In this case, the contract analysis unit 13 calculates the amounts of risks by multiplying the probabilities that the respective contractors will go to the site of the court by the costs associated with actual going to the court due to the costs being influential and weighs the amount of transactions and the real profits obtained by subtracting the selling, general and administrative expenses from the gross profits (step S102). The contract analysis results presentation unit 14 shows, to the user, the description of a well-balanced contract serving as the central state (step S103). More specifically, the contract analysis results presentation unit 14 balances the probabilities that the contractors will actually go to court, the business trip expenses, and the profits earned due to the transactions and shows, to the user, information indicating that when the amount of transactions between the company A and company B is 1 million yen, the central state is obtained by specifying a court having jurisdiction over Tokyo as the court of jurisdiction and when the amount of transactions is 2 million yen, the central state is obtained by specifying a court having jurisdiction over Fukuoka as the court of jurisdiction.

### Example Operation 3

It is assumed that one of the premise items set by the contract terms setting unit 11 is liability for damages between contractors and the simulation item is the amount of transactions between the contractors. In this case, the contract analysis unit 13 calculates the amounts of risks of the contractors on the basis of the amount of damages corresponding to the probabilities that damage will occur in the respective contractors and liability for damages associated with the occurrence of damage, calculates the real profits earned by the contractors due to transactions between the contractors, and determines the amount of transactions corresponding to the central state by changing the amount of transactions between the contractors, which is the simulation item.

A specific example is as follows. It is assumed that one of the premise items states that the company B wants the company A to bear the liability for damages including even slight negligence in transactions between the company A and company B and the simulation item is the annual amount of transactions that the company A requests from the company B (step S101 in FIG. 3). In this case, the contract analysis unit 13 calculates the central value of the amount of transactions as eight hundred thousand yen from the probabilities and the amount of transactions, since, according to the contract analysis data, the risk is high when there is no exemption from liability for slight negligence. On the other hand, if one of the premise items is changed to one stating that there is an exemption from liability for slight negligence (step S104: Yes), the contract analysis unit 13 calculates the central value of the amount of transactions as five hundred thousand yen.

As described above, the contract assistance system 1 analyzes and presents the central state, which makes the content of the contract fair between the contractors, on the basis of the contract analysis data and the set contract terms. Thus, the contract assistance system 1 allows the user to know the content of the contract that is fair between the contractors, that is, assists the user in making the contract.

When the words of the contract displayed on the user terminal 20 are changed, the contract assistance system 1 re-analyzes and presents the risk changed due to the change. Thus, the user is able to grasp, on the screen, changes in the risk associated with changes in the words of the contract one after another.

The above embodiment is illustrative only, and the present invention can also be carried out by making various modifications to the embodiment without departing from the spirit and scope of the invention as set forth in the claims.

For example, while, in the above example, the contract between the two companies, the company A and company B, has been described, the number of contractors may be three or more or one.

While, in the above embodiment, the communication system of the contract assistance system 1 has been described as a client-server system, this is not limiting. The communication system may be, for example, blockchain communication, pier-to-pier (P2P) communication, communication using a distributed storage blockchain, a combination thereof, or a communication system to be developed in the future.

The contract assistance system 1 may consist of a single device. If the contract assistance system 1 consists of a single device, this device may be a stand-alone device, which is not connected to the communication network 30 such as the Internet.

What is claimed is:

1. A contract assistance system for assisting in analysis of a contract to be made between contractors, comprising:
a contract terms setting unit configured to set contract terms including premise items serving as premises of the contract and a simulation item to be simulated;
a contract analysis data storage unit configured to store contract analysis data used to analyze the contract;
a contract analysis unit configured to analyze a central state of the simulation item that makes content of the contract fair between the contractors, on the basis of the contract analysis data stored in the contract analysis data storage unit and the contract terms set by the contract terms setting unit; and
a contract analysis results presentation unit configured to present analysis results obtained by the contract analysis unit.

2. The contract assistance system of claim 1,
wherein the contract analysis unit is configured to determine, as the central state, a state in which risks borne by the contractors and profits earned by the contractors are balanced, by changing the simulation item, and
wherein the contract analysis results presentation unit is configured to present information on the central state determined by the contract analysis unit.

3. The contract assistance system of claim 2, wherein the contract analysis unit is configured to calculate the risks borne by the contractors by determining a risk factor and a cost factor for each of words of the contract and calculating the probabilities that the risk factor and the cost factor respectively will occur.

4. The contract assistance system of claim 3,
wherein when the words of the contract constituting the premise items are changed, the contract terms setting unit is configured to change the set premise items, and
wherein the contract analysis unit is configured to re-analyze the central state of the simulation item on the changed premise items.

5. The contract assistance system of claim 4,
wherein the contract analysis unit is configured to re-analyze the risks changed responsive to the words of the contract being changed,
wherein the contract analysis results presentation unit is configured to present information on the re-analyzed risks such that the information is associated with the changed words.

6. A contract assistance system for assisting in analysis of a contract to be made between contractors, comprising:
a contract terms setting unit configured to set contract terms including premise items serving as premises of the contract and a simulation item to be simulated on the basis of input of a setting from outside;
a contract analysis data storage unit configured to store contract analysis data including simulation learning data, standard profit calculation data for calculating the amounts of standard profits earned by the contractors in accordance with content of the contract between the contractors, and risk amount calculation data for calculating the amounts of risks on the basis of a risk factor and a cost factor that may occur in the respective contractors, the contract analysis data being used to simulate a central state in which real profits obtained by subtracting the amounts of risks borne by the contractors from gross profits earned by the contractors become the amounts of standard profits, by changing the simulation item;
a contract analysis unit configured to analyze a state of the simulation item in which the central state is obtained, on the basis of the contract analysis data stored in the contract analysis data storage unit and the contract terms set by the contract terms setting unit; and
a contract analysis results presentation unit configured to present analysis results obtained by the contract analysis unit,
wherein when words of the contract constituting the premise items are changed, the contract terms setting unit is configured to change the set premise items, and
wherein the contract analysis unit is configured to re-analyze the state of the simulation item in which the central state is obtained, on the basis of the changed premise items.

7. The contract assistance system of claim 6,
wherein if the premise items set by the contract terms setting unit are addresses of the contractors and the simulation item is a court of jurisdiction and the amount of transactions between the contractors, the contract analysis unit is configured to calculate the amounts of risks of the contractors on the basis of the probabilities that the contractors respectively will go to the court of jurisdiction and costs associated with going of the contractors to the court of jurisdiction, to calculate the real profits earned by the contractors due to the transactions between the contractors, and to determine the central state that corresponds to the amount of transactions and in which a court having jurisdiction over the address of one of the contractors is specified as the court of jurisdiction, by changing the court of jurisdiction and the amount of transactions between the contractors being the simulation item.

8. The contract assistance system of claim 6,
wherein if the premise items set by the contract terms setting unit are liability for damages between the contractors and the simulation item is the amount of transactions between the contractors, the contract analysis unit is configured to calculate the amounts of risks of the contractors on the basis of the probabilities that damage will occur in the respective contractors and the amounts of damages corresponding to the liability for damages associated with occurrence of damage, to calculate the real profits earned by the contractors due to the transactions between the contractors, and to determine the amount of transactions at which the central state is obtained, by changing the amount of transactions between the contractors being the simulation item.

9. The contract assistance system of claim 6,
wherein if the simulation item is not set in accordance with input of a setting from outside, the contract terms setting unit is configured to set the real profits of the contractors as the simulation item that is a default, and
wherein the contract analysis results presentation unit is configured to present the real profits and the standard profits of the contractors and size relationships between the real profits and the standard profits.

10. The contract assistance system of claim 6, further comprising a standard data storage unit configured to store standard data representing standard contracts corresponding to industries or transaction forms and central states determined on the basis of the standard contracts, wherein
if the contract analysis unit cannot determine the central state, the contract analysis results presentation unit is configured to present the standard data stored in the standard data storage unit in accordance with industries of the contractors or a transaction form between the contractors.

11. A computer program product for causing a computer to function as: contract terms setting means configured to set contract terms including premise items serving as premises of a contract to be made between contractors and a simulation item to be simulated;
contract analysis data storage means configured to store contract analysis data including simulation learning data, standard profit calculation data for calculating the amounts of standard profits earned by the contractors in accordance with content of the contract between the contractors, and risk amount calculation data for calculating the amounts of risks on the basis of a risk factor and a cost factor that may occur in the respective contractors, the contract analysis data being used to simulate a central state in which real profits obtained by subtracting the amounts of risks borne by the contractors from gross profits earned by the contractors become the amounts of standard profits, by changing the simulation item;
contract analysis means configured to analyze a state of the simulation item in which the central state is obtained, on the basis of the contract analysis data stored in the contract analysis data storage means and the contract terms set by the contract terms setting means; and
contract analysis results presentation means configured to present analysis results obtained by the contract analysis means,
wherein when words of the contract constituting the premise items are changed, the contract terms setting means is configured to change the set premise items, and
wherein the contract analysis means is configured to re-analyze the state of the simulation item in which the central state is obtained, on the basis of the changed premise items.
